(19) United States
(12) Patent Application Publication
(10) Pub. No.: US 2025/0084601 A1
(43) Pub. Date: Mar. 13, 2025

(54) TRAP ESCAPING AND SNOW REMOVAL METHOD, DEVICE AND SNOW SWEEPER

(71) Applicant: SHENZHEN HANYANG TECHNOLOGY CO., LTD., Shenzhen (CN)

(72) Inventors: Yang HUANG, Shenzhen (CN); Wei ZHANG, Shenzhen (CN); Chuwei ZHENG, Shenzhen (CN)

(73) Assignee: SHENZHEN HANYANG TECHNOLOGY CO., LTD., Shenzhen (CN)

(21) Appl. No.: 18/824,707

(22) Filed: Sep. 4, 2024

Related U.S. Application Data
(63) Continuation of application No. PCT/CN2023/129981, filed on Nov. 6, 2023.

(30) Foreign Application Priority Data
Sep. 11, 2023 (CN) 202311174436.8

(51) Int. Cl. E01H 5/09

(52) U.S. Cl. CPC E01H 5/092

(57) ABSTRACT

A trap escaping and snow removal method includes: performing, when a snow sweeper detects that a current snow shoveling position is in a trigger condition for trap escaping, a corresponding preset trap escaping action, wherein the preset trap escaping action includes the following steps: adjusting a head-up height of a snow shovel head of the snow sweeper at least once; determining, after finishing the preset trap escaping action, whether it is still in the trigger condition for trap escaping; and if not, determining a next snow shoveling position and performing a snow shoveling operation.

### CROSS-REFERENCE TO RELATED APPLICATIONS

This application is a continuation of International Application No. PCT/CN2023/129981, filed on Nov. 6, 2023, which claims priority to Chinese Patent Application No. 202311174436.8, filed on Sep. 11, 2023. The disclosures of the above-mentioned applications are hereby incorporated by reference in their entireties.

### TECHNICAL FIELD

The application relates to the technical field of snow sweeper, in particular to a trap escaping and snow removal method, a trap escaping and snow removal device and a snow sweeper.

### BACKGROUND

With the current snow sweeper, the machine path is generated after the direction of the sweeper's movement is manually adjusted. The inventors realized that the snow sweeper could not move in this manner because it could easily climb onto the snow if it bumped into icicles or cracks in the ground. This would cause the snow sweeper to skid and reduce its efficiency at sweeping snow. The typical way for a snow sweeper to get out of a trap is to return to the original path, which lengthens the detour and reduces the sweeper's effectiveness.

The information above is not an acknowledgment that it is prior art; rather, it is merely intended to aid in understanding the technical solution of this application.

### SUMMARY

The application provides a trap escaping and snow removal method, a trap escaping and snow removal device and a snow sweeper, aiming at addressing the technical problem that in the prior art, the detour is longer and the effectiveness is decreased because the conventional approach for a snow sweeper to escape a trap is to return to the original path.

In order to achieve the above purpose, the application provides a trap escaping and snow removal method, which includes the following steps:
performing, when a snow sweeper detects that a current snow shoveling position is in a trigger condition for trap escaping, a corresponding preset trap escaping action, wherein the preset trap escaping action includes the following steps: adjusting a head-up height of a snow shovel head of the snow sweeper at least once;
determining, after finishing the preset trap escaping action, whether it is still in the trigger condition for trap escaping; and
if not, determining a next snow shoveling position and performing a snow shoveling operation.

In addition, in order to achieve the above purpose, the application also provides a trap escaping and snow removal device, which includes:
a detection module, configured for performing, when a snow sweeper detects that a current snow shoveling position is in a trigger condition for trap escaping, a corresponding preset trap escaping action, wherein the preset trap escaping action includes the following steps: adjusting a head-up height of a snow shovel head of the snow sweeper at least once;
a determination module, configured for determining, after finishing the preset trap escaping action, whether it is still in the trigger condition for trap escaping; and
a snow shoveling module, configured for determining a next snow shoveling position and performing a snow shoveling operation.

In addition, in order to achieve the above purpose, the application further provides a snow sweeper, which includes a snow shovel head, a snow sweeper body and one or more controllers; the snow shovel head is detachably connected to the snow sweeper body, one or more controllers are arranged on the snow sweeper body, one or more controllers are used for controlling the snow shovel head and a snow shovel motor, and one or more controllers can run a trap escaping and snow removal program, and the trap escaping and snow removal program is configured for realizing the following steps:
performing, when a snow sweeper detects that a current snow shoveling position is in a trigger condition for trap escaping, a corresponding preset trap escaping action, wherein the preset trap escaping action includes the following steps: adjusting a head-up height of a snow shovel head of the snow sweeper at least once;
determining, after finishing the preset trap escaping action, whether it is still in the trigger condition for trap escaping; and
if not, determining a next snow shoveling position and performing a snow shoveling operation.

According to the present application, when a snow sweeper detects that a current snow shoveling position is in a trigger condition for trap escaping, performing a corresponding preset trap escaping action, and the preset trap escaping action includes the following steps: adjusting a head-up height of a snow shovel head of the snow sweeper at least once; after finishing the preset trap escaping action, determining whether it is still in the trigger condition for trap escaping; and if not, determining a next snow shoveling position and performing a snow shoveling operation. According to the application, in order to solve the technical problem of the longer detour and decreased effectiveness due to the conventional approach of a snow sweeper escaping a trap being to return to the original path, the preset trap escaping action is activated by detecting the trigger condition for trap escaping, and the head-up height of the snow shovel head is adjusted to perform the trap escaping operation. This increases the snow sweeper's efficiency when shoveling snow.

Details of one or more embodiments of the application are set forth in the following drawings and descriptions, and other features and advantages of the application will be apparent from the description, drawings and claims.

### BRIEF DESCRIPTION OF THE DRAWINGS

FIG. 1 is a structural schematic diagram of a snow sweeper in a hardware operational environment according to an embodiment of the present application.

FIG. 2 is a schematic flow chart of a trap escaping and snow removal method according to the first embodiment.

FIG. 3 is a schematic flow chart of a trap escaping and snow removal method according to the second embodiment.

FIG. 4 is a structural diagram of a trap escaping and snow removal device according to the first embodiment.

The purposes, implementations, technical features and advantages of the application will be further explained with reference to the attached drawings and embodiments.

### DETAILED DESCRIPTION OF THE EMBODIMENTS

It should be understood that the specific embodiments described herein are merely intended to clarify the application rather than limit it.

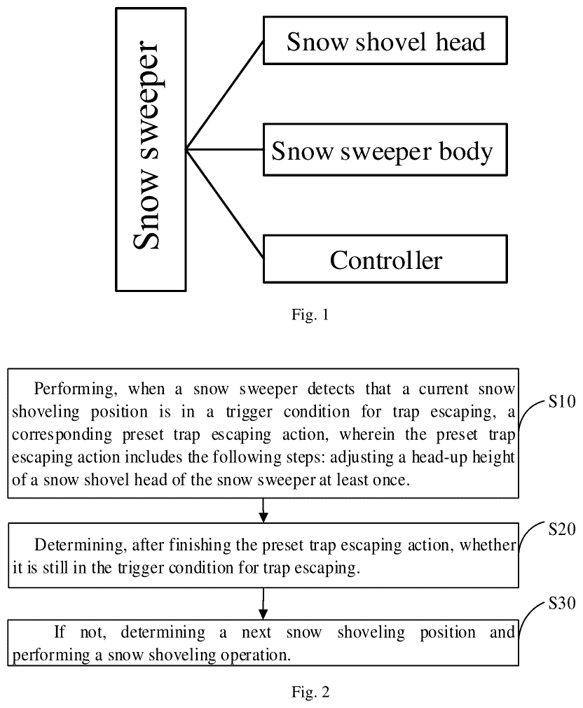

FIG. 1 is a schematic structural diagram of a snow sweeper of a hardware operational environment according to an embodiment of the present application.

As shown in FIG. 1, the snow sweeper includes a snow shovel head, a snow sweeper body and one or more controllers; the snow shovel head is detachably connected to the snow sweeper body, one or more controllers are arranged on the snow sweeper body, one or more controllers are used for controlling the snow shovel head and a snow shovel motor, and one or more controllers can run a trap escaping and snow removal program, and the trap escaping and snow removal program is configured for realizing the steps of the trap escaping and snow removal method described above. The snow sweeper executes the trap escaping and snow removal method provided by the present application.

Those skilled in the art can understand that the structure depicted in FIG. 1 is not exclusive to snow sweepers and can have alternative component arrangements, combine certain components, or have more or less components than those illustrated.

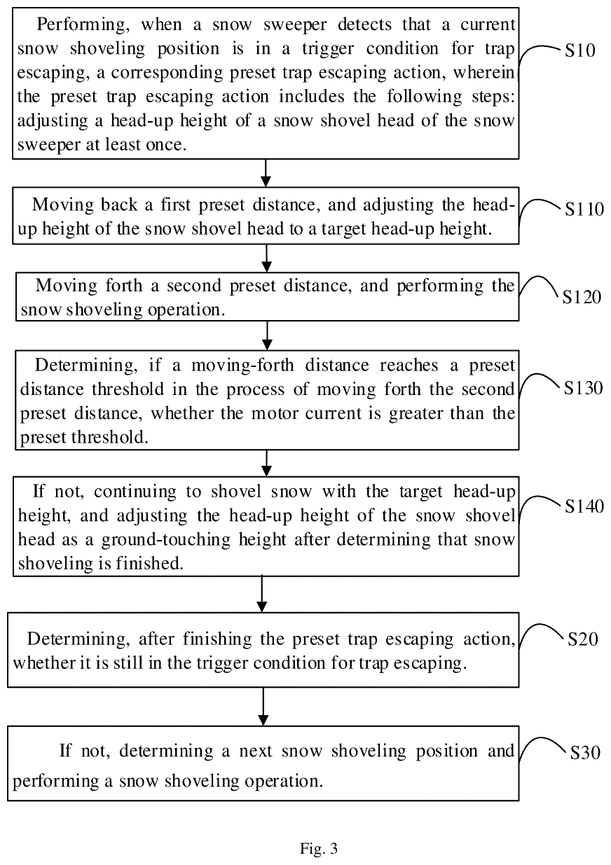

As illustrated in FIG. 2, a schematic flow chart of a trap escaping and snow removal method according to the first embodiment, the embodiment of the present application provides a trap escaping and snow removal method.

In this embodiment, the trigger condition for trap escaping includes a first trigger condition for trap escaping and/or a second trigger condition for trap escaping, and the first trigger condition for trap escaping is: the snow sweeper skids when it is not the first time for the snow sweeper to perform the automatic snow shoveling operation or a motor current of the snow sweeper is greater than a preset threshold. The first trigger condition for trap escaping can be realized on the basis that the snow sweeper does not trigger the second trigger condition for trap escaping, and can also be realized on the basis that the snow sweeper triggers the second trigger condition for trap escaping. The second trigger condition for trap escaping is that: the snow sweeper performs the automatic snow shoveling operation for the first time or a marked position is manually activated. And the second trigger condition for trap escaping can be realized separately. The trap escaping and snow removal method includes the follow steps:

Step S10: performing, when a snow sweeper detects that a current snow shoveling position is in a trigger condition for trap escaping, a corresponding preset trap escaping action, wherein the preset trap escaping action includes the following steps: adjusting a head-up height of a snow shovel head of the snow sweeper at least once.

It should be noted that the method of this embodiment can be used in any situation where snow shoveling is required, and the executor of this embodiment might be the aforementioned snow sweeper or other equipment that can do the same or comparable activities. In this application, the above-mentioned snow sweeper is used to specifically explain this embodiment and the following examples.

It should be noted that the above-mentioned current snow shoveling position may be the position that snow sweeper is traveling in the process of shoveling snow according to the preset snow sweeping path. In this embodiment, the snow sweeping path is connected using position coordinates one by one.

It should be noted that the above-mentioned trigger condition for trap escaping could be the condition in which the snow sweeper moves onto a snowdrift when encountering ground bumps, icicles, or ground cracks during the snow shoveling process, and the position of the snow sweeper as determined by the snow sweeper's positioning sensor has not changed, but the snow sweeper's wheel is detected to move.

It should be noted that the aforementioned preset trap escaping action can activate the corresponding trap escaping action when the snow sweeper detects that it is in the preset trigger condition for trap escaping, allowing the sweeper to get rid of the situation in which the snow sweeper slips on the snowdrift when it encounters ground bumps, icicles, or ground cracks.

It can be understood that the head-up height of the snow shovel head can be adjusted by adjusting the push rod value, so that the snow shovel head of the snow sweeper can be lifted up by a certain distance, i.e., the height of the snow shovel head from the ground. The snow shovel head of the snow sweeper can be set to four levels, with the head-up heights corresponding to the four levels being 1 cm, 2 cm, 3 cm, and 5 cm, with the first level having a head-up height of 1 cm and the fourth having a head-up height of 5 cm.

It should be noted that the above-mentioned snow shoveling operation might be an operation for shoveling snow when the snow sweeper is running. In this embodiment, it may be an operation for snow sweeper to adjust the high-speed rotation of the snow rolling blade and the snow throwing blade during moving.

In specific implementation, the snow sweeper of this embodiment executes the corresponding preset trap escaping action under the condition that it detects that the position of snow sweeper determined by the positioning sensor of snow sweeper has not changed, but the wheel of snow sweeper has moved, and the preset trap escaping action includes: adjusting the head-up height of the snow shovel head of the snow sweeper at least once.

Step S20: determining, after finishing the preset trap escaping action, whether it is still in the trigger condition for trap escaping.

In specific implementation, the snow sweeper determines whether it is still in the trigger condition for trap escaping after completing the preset trap escaping action. If it is not in the trigger condition for trap escaping, it indicates that the trap escaping and snow removal operation is successful. If it is still in the trigger condition, it indicates that the height of snow sweeper's snow shovel head is adjusted to the highest height and still meets the trigger condition. The snow sweeper therefore fails to implement the trap escaping and snow removal operation, and users need to be informed to implement other solutions.

Step S30: if not, determining a next snow shoveling position and performing a snow shoveling operation.

In specific implementation, if it is not in the trigger condition, the next target position will be determined according to the preset path, and the snow shoveling operation will continue to be performed.

According to this embodiment, when a snow sweeper detects that a current snow shoveling position is in a trigger condition for trap escaping, performing a corresponding preset trap escaping action, and the preset trap escaping action includes the following steps: adjusting a head-up height of a snow shovel head of the snow sweeper at least once; after finishing the preset trap escaping action, determining whether it is still in the trigger condition for trap escaping; and if not, determining a next snow shoveling position and performing a snow shoveling operation. According to this embodiment, in order to solve the technical problem of the longer detour and decreased effectiveness due to the conventional approach of a snow sweeper escaping a trap being to return to the original path, the preset trap escaping action is activated by detecting the trigger condition for trap escaping, and the head-up height of the snow shovel head is adjusted to perform the trap escaping operation. This increases the snow sweeper's efficiency when shoveling snow.

Referring to FIG. 3, a schematic flow chart of a trap escaping and snow removal method according to the second embodiment is provided.

Based on the above-mentioned first embodiment, in this embodiment, the trigger condition for trap escaping includes a first trigger condition for trap escaping, and the first trigger condition for trap escaping is: the snow sweeper skids when it is not the first time for the snow sweeper to perform the automatic snow shoveling operation or a motor current of the snow sweeper is greater than a preset threshold. Accordingly, the preset trap escaping action includes the following steps.

It should be understood that the first trigger condition for trap escaping might be the situation that the snow sweeper still skids under the condition that the second trigger condition for trap escaping has been triggered.

It should be noted that the above-mentioned first trigger condition for trap escaping may be the snow shoveling operation carried out by the snow sweeper after the topographic record.

Step S110: moving back a first preset distance, and adjusting the head-up height of the snow shovel head to a target head-up height.

It should be noted that the above-mentioned target head-up height may be the head-up height to which the snow shovel head is about to be adjusted.

Step S120: moving forth a second preset distance, and performing the snow shoveling operation.

Step S130: determining, if a moving-forth distance reaches a preset distance threshold in the process of moving forth the second preset distance, whether the motor current is greater than the preset threshold.

It should be noted that whether snow sweeper shoveled snow or not can be determined by the current magnitude of the motor current (motor load). Specifically, it is determined whether the current is greater than a preset threshold, such as 17A. If yes, it means that the snow sweeper is in a state of snow shoveling, and if no, it means that snow sweeper is in a state of no snow shoveling.

It should be understood that the preset distance threshold may be a value greater than 0 and less than the second preset distance. When the snow sweeper moves forth the second preset distance and the moving-forth distance reaches the preset distance threshold, it is determined whether the snow sweeper is shoveling snow or not, and whether the trigger condition for trap escaping is thick and hard snow, ground cracks, terrain bumps, or icicles.

Step S140: if not, continuing to shovel snow with the target head-up height, and adjusting the head-up height of the snow shovel head as a ground-touching height after determining that snow shoveling is finished.

It should be noted that the above-mentioned ground-touching height may be the height that the snow shovel head of snow sweeper clings to the ground, that is, the head-up height of the snow shovel head from the ground is 0.

It should be noted that if the motor current of snow sweeper is less than or equal to the preset threshold value, the current trigger condition for trap escaping is ground crack/terrain bulge/icicle.

In specific implementation, when it is detected that the current snow shoveling position of snow sweeper is in the first condition for trap escaping, moving back a first preset distance, and adjusting the head-up height of the snow shovel head to a target head-up height; moving forth a second preset distance, and performing the snow shoveling operation; determining, if a moving-forth distance reaches a preset distance threshold in the process of moving forth the second preset distance, whether the motor current is greater than the preset threshold; and if not, continuing to shovel snow with the target head-up height, and adjusting the head-up height of the snow shovel head as a ground-touching height after determining that snow shoveling is finished. Specifically, when the snow sweeper detects that the current snow shoveling position is in the trigger condition for trap escaping without topographic records, it moves back by 50 cm, adjusts the head-up height of the snow shovel head to 3 cm, and then moves forth by 65 cm. When moving forth to 55 cm, if the motor current of snow sweeper is less than or equal to 17A, it indicates that the snow sweeper has crossed the ground and escaped the trap.

Further, in this embodiment, the above step S130 is followed by:

Step S131: if yes, moving back the first preset distance on the basis of the moving-forth distance, and adjusting the head-up height of the snow shovel head as the ground-touching height.

It should be noted that if the motor current of the snow sweeper is greater than the preset threshold, it means that the current trigger condition for trap escaping is thick and hard snow.

Step S132: continuing to move forth the second preset distance, and keeping the head-up height of the snow shovel head as the ground-touching height in the process of going to the next snow shoveling position.

In specific implementation, the snow sweeper will keep the head-up height of the snow shovel head at the height of touching the ground when going to the next snow shoveling position. If the next snow shoveling position is the marked position in the topographic record, the ground-touching height is directly adjusted to the head-up height corresponding to the position of the topographic record. If the next snow shoveling position is the marked position in the topographic record, it passes the position with the head-up height in the topographic record, and it is determined that skidding occurs, then the preset trap escaping action corresponding to the first trigger condition for trap escaping is executed, including: the snow sweeper moves back by 50 cm, adjusts the head-up height of the snow shovel head to 3 cm, and then moves forth by 65 cm. When moving forth to 55 cm, if the motor current of snow sweeper is greater than the preset threshold, it is determined that the snow sweeper has encountered thick and hard snow. Then the snow sweeper will continue to move forth to 65 cm, and continue to move back to 50 cm, adjust the head-up height of the snow shovel head to the ground-touching height, and then move forth by 65 cm to remove the thick and hard snow and return to the regular automatic snow sweeping plan. If the next snow shoveling position is not the marked position in the topographic record, and it is determined that skidding occurs, the preset trap escaping action corresponding to the first trigger condition for trap escaping will continue to be executed, specifically as described above.

Further, in this embodiment, the trigger condition for trap escaping includes a second trigger condition for trap escaping, and the second trigger condition for trap escaping is: the snow sweeper skids after the snow sweeper performs the automatic snow shoveling operation for the first time or a marked position is manually activated; and the preset trap escaping action includes the following steps.

It should be noted that the above-mentioned second trigger condition may be the behavior in the topographic record of the snow sweeper. The topographic record records the position of ground fissures/topographic protrusions/icicles and the head-up height of the corresponding snow shovel.

Step S210: adjusting the head-up height of the snow shovel head from the ground-touching height according to a preset height interval.

It should be noted that the above-mentioned preset height interval may be a height interval for realizing height adjustment based on the preset height levels of the snow sweeper. Specifically, the height interval for adjusting from level 1 (1 cm) to level 2 (2 cm) is 1 cm.

Step S220: determining whether the snow sweeper at the current snow shoveling position skids based on positioning information of the snow sweeper.

Step S230: if yes, returning to the step of adjusting the head-up height of the snow shovel head according to the preset height interval until the head-up height of the snow shovel head is adjusted to an upper limit value of the head-up height of the snow shovel head, taking the current snow shoveling position as the marked position, and recording the marked position and a marked head-up height corresponding to the marked position.

Step S240: if not, taking the current snow shoveling position as the marked position, and recording the marked position and a marked head-up height corresponding to the marked position.

It should be noted that the above-mentioned mark position may be the position where the terrain (ground fissure/terrain bulge/icicle) needs to be recorded.

It should be understood that the head-up height of the above-mentioned mark may be the head-up height of the snow shovel when the snow sweeper is in the process of performing the trap escaping action.

In specific implementation, the marked position of ground fissure/terrain bulge/icicle is recorded, and the head-up height of the snow shovel head may be adjusted to the marked height when moving to this position in the later process of escaping the trap.

In this embodiment, if the head-up height of the above-mentioned mark is less than or equal to the preset head-up height, after the snow sweeper moves by one preset moving distance, the snow shovel head is adjusted while moving, and the head-up angle is restored to the default angle. If the above-mentioned marked head-up height is greater than the preset head-up height, after the snow sweeper moves by two preset moving distances, it is first determined whether the current inclination angle is consistent with the default angle; if not, the snow sweeper will restore the head-up angle to the default angle; if yes, it will continue to keep the current head-up height while moving by one preset distance, and repeat the step of determining whether the above angles are consistent. Here, one preset moving distance may be 20-40 cm, preferably 30 cm.

Further, in this embodiment, the trap escaping and snow removal method further includes:

S40: adjusting, when the snow sweeper moves to the marked position corresponding to the next snow shoveling position, the head-up height of the snow sweeper to the marked head-up height.

It should be noted that, on the basis of the first trigger condition for trap escaping (topographic record), when the snow sweeper runs to the marked position corresponding to the next snow shoveling position, the head-up height of the snow shovel head will be adjusted to the marked height recorded above.

Further, in this embodiment, the trap escaping and snow removal method further includes:

Step S250: detecting, when the snow sweeper performs the automatic snow shoveling operation for the first time, whether the motor current of the snow sweeper is greater than a preset threshold.

Step S260: if yes, adjusting the head-up height of the snow shovel head as the ground-touching height to shovel snow.

Step S270: determine the next target position to perform the snow shoveling operation.

In specific implementation, under the condition that the snow sweeper automatically performs the snow shoveling operation for the first time, it is detected whether the motor current of the snow sweeper is greater than a preset threshold; if the motor current of the snow sweeper is greater than the preset threshold, it means that snow sweeper is in a snow shoveling state, and the snow shoveling head is adjusted to the ground-touching height for snow shoveling.

Further, in this embodiment, the above step S10 is followed by:

Step S1l: determining the current snow shoveling position based on positioning information, and determining whether the current snow shoveling position exceeds a boundary.

It should be noted that the positioning information may be the position information of longitude and latitude. The positioning information can be determined by fusion positioning of snow sweeper positioning sensor and RTK (Real-Time Kinematics, a technology for real-time dynamic relative positioning by GPS carrier phase observation and also a detection device, which can receive satellite signals to achieve high-precision positioning), and the positioning sensor may include IMU (Inertial Measurement Unit) and odometer.

In specific implementation, the positioning information is obtained through the positioning sensor, the current snow shoveling position is determined, and whether the current snow shoveling position is within the preset path range is determined; if it is within the preset path range, it is not beyond the boundary; if it is not within the preset map, it is beyond the boundary.

Step S12: if yes, acquiring a historical coordinate position determined based on the positioning information and moving back to a historical position corresponding to the historical coordinate position, and continuing the snow shoveling operation.

In specific implementation, if it is beyond the boundary, that is, not within the path range, the coordinate position (historical coordinate position) of the last snow shoveling operation is obtained, and it returns to the historical position corresponding to the historical coordinate position, and the snow shoveling operation is continued.

Further, in this embodiment, the trap escaping and snow removal method further includes:

Step S50: determining a target push rod value according to the relationship between a push rod value and the head-up height of the snow shovel head when adjusting the head-up height of the snow shovel head of the snow sweeper.

It should be noted that the push rod may be a device used by the snow sweeper to alter the head-up height of the snow shovel head, with different push rod values corresponding to different heights of the snow shovel head.

Step S60: adjusting a current push rod value as the target push rod value to adjust the head-up height of the snow shovel head.

In this embodiment, the maximum height of the snow shovel head is 5 cm, and the push rod value is 0, and the minimum height of the snow shovel head is 0 cm. in this state, the push rod value is 64, and when the snow shovel head height is 3 cm, the push rod value is 20. It can be seen that the head-up height of the snow shovel is determined by controlling the push rod value of snow sweeper, and the relationship between the push rod value and the head-up height of the snow shovel is nonlinear (curved). adjusting a current push rod value as the target push rod value to adjust the head-up height of the snow shovel head.

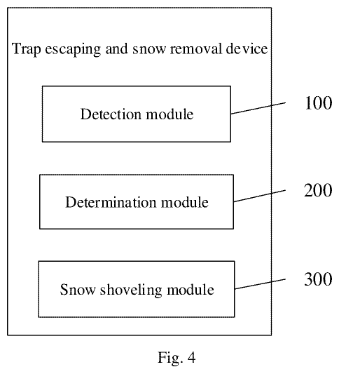

Referring to FIG. 4, a structural diagram of a trap escaping and snow removal device according to the first embodiment is provided.

As shown in FIG. 4, the trap escaping and snow removal device provided by the embodiment of the application includes:
a detection module 100, configured for performing, when a snow sweeper detects that a current snow shoveling position is in a trigger condition for trap escaping, a corresponding preset trap escaping action, wherein the preset trap escaping action includes the following steps: adjusting a head-up height of a snow shovel head of the snow sweeper at least once;
a determination module 200, configured for determining, after finishing the preset trap escaping action, whether it is still in the trigger condition for trap escaping; and
a snow shoveling module 300, configured for determining a next snow shoveling position and performing a snow shoveling operation.

According to this embodiment, when a snow sweeper detects that a current snow shoveling position is in a trigger condition for trap escaping, performing a corresponding preset trap escaping action, and the preset trap escaping action includes the following steps: adjusting a head-up height of a snow shovel head of the snow sweeper at least once; after finishing the preset trap escaping action, determining whether it is still in the trigger condition for trap escaping; and if not, determining a next snow shoveling position and performing a snow shoveling operation. According to this embodiment, in order to solve the technical problem of the longer detour and decreased effectiveness due to the conventional approach of a snow sweeper escaping a trap being to return to the original path, the preset trap escaping action is activated by detecting the trigger condition for trap escaping, and the head-up height of the snow shovel head is adjusted to perform the trap escaping operation. This increases the snow sweeper's efficiency when shoveling snow.

Other embodiments or specific implementations of the trap escaping and snow removal device provided by this application are not duplicated here, but can be found in the aforementioned method embodiments.

It should be noted that in this paper, the terms “include”, “comprise” or any other variation thereof are intended to cover non-exclusive subject-matter. A process, method, article or system including a series of elements includes not only those elements, but also other elements not explicitly listed, or elements inherent to such process, method, article or system. Without more restrictions, an element defined by the phrase “including a” does not exclude the existence of other identical elements in the process, method, article or system.

The above numbers of the embodiments of the present application are only for description, and do not indicate priorities of the embodiments.

With the description of the above embodiments, those skilled in the art can clearly understand that the methods of the above embodiments can be realized by means of software and necessary general hardware platform. Alternatively, they can be realized by hardware, but in many cases, the former is the better one. Based on this understanding, the technical solution of this application can be embodied in the form of a software product, which is stored in a storage medium, such as Read Only Memory (ROM), Random Access Memory (RAM), magnetic disk, optical disk, etc., and includes several instructions to enable a terminal device (e.g., mobile phone, computer, server, or network device, etc.) to execute the methods described in the embodiments of this application.

The above are merely the preferred embodiments of the present application, they do not restrict the patent scope of this application. Any equivalent structure or equivalent process transformation made with the contents of this application description and drawings, or directly or indirectly used in other related technical fields, shall be included in the patent protection scope of this application.

What is claimed is:

1. A trap escaping and snow removal method, comprising:
performing, when a snow sweeper detects that a current snow shoveling position is in a trigger condition for trap escaping, a corresponding preset trap escaping action, wherein the preset trap escaping action comprises following steps: adjusting a head-up height of a snow shovel head of the snow sweeper at least once;
determining, after finishing the preset trap escaping action, whether it is still in the trigger condition for trap escaping; and
if not, determining a next snow shoveling position and performing a snow shoveling operation.

2. The trap escaping and snow removal method of claim 1, wherein the trigger condition for trap escaping comprises a first trigger condition for trap escaping, and the first trigger condition for trap escaping is: the snow sweeper skids when it is not a first time for the snow sweeper to perform an automatic snow shoveling operation or a motor current of the snow sweeper is greater than a preset threshold;
the preset trap escaping action comprises the following steps:
moving back a first preset distance, and adjusting the head-up height of the snow shovel head to a target head-up height;
moving forth a second preset distance, and performing the snow shoveling operation;
determining, if a moving-forth distance reaches a preset distance threshold in the process of moving forth the second preset distance, whether the motor current is greater than the preset threshold; and
if not, continuing to shovel snow with the target head-up height, and adjusting the head-up height of the snow shovel head as a ground-touching height after determining that snow shoveling is finished.

3. The trap escaping and snow removal method of claim 2, wherein after the step of determining, if a moving-forth distance reaches a preset distance threshold in the process of moving forth the second preset distance, whether the motor current is greater than the preset threshold, the method further comprises:
if yes, moving back the first preset distance on the basis of the moving-forth distance, and adjusting the head-up height of the snow shovel head as the ground-touching height; and
continuing to move forth the second preset distance, and keeping the head-up height of the snow shovel head as the ground-touching height in the process of going to the next snow shoveling position.

4. The trap escaping and snow removal method of claim 1, wherein the trigger condition for trap escaping comprises a second trigger condition for trap escaping, and the second trigger condition for trap escaping is: the snow sweeper skids after the snow sweeper performs the automatic snow shoveling operation for the first time or a marked position is manually activated;
the preset trap escaping action further comprises the following steps:
adjusting the head-up height of the snow shovel head from the ground-touching height according to a preset height interval;
determining whether the snow sweeper at the current snow shoveling position skids based on positioning information of the snow sweeper;
if yes, returning to the step of adjusting the head-up height of the snow shovel head according to the preset height interval until the head-up height of the snow shovel head is adjusted to an upper limit value of the head-up height of the snow shovel head, taking the current snow shoveling position as the marked position, and recording the marked position and a marked head-up height corresponding to the marked position; and
if not, taking the current snow shoveling position as the marked position, and recording the marked position and a marked head-up height corresponding to the marked position.

5. The trap escaping and snow removal method of claim 4, further comprising:
adjusting, when the snow sweeper moves to the marked position corresponding to the next snow shoveling position, the head-up height of the snow sweeper to the marked head-up height.

6. The trap escaping and snow removal method of claim 1, further comprising:
detecting, when the snow sweeper performs the automatic snow shoveling operation for the first time, whether the motor current of the snow sweeper is greater than a preset threshold;
if yes, adjusting the head-up height of the snow shovel head as the ground-touching height to shovel snow; and
determine the next target position to perform the snow shoveling operation.

7. The trap escaping and snow removal method of claim 1, wherein after the step of performing, when a snow sweeper detects that a current snow shoveling position is in a trigger condition for trap escaping, a corresponding preset trap escaping action, the method further comprises:
determining the current snow shoveling position based on positioning information, and determining whether the current snow shoveling position exceeds a boundary; and
if yes, acquiring a historical coordinate position determined based on the positioning information and moving back to a historical position corresponding to the historical coordinate position, and continuing the snow shoveling operation.

8. The trap escaping and snow removal method of claim 7, wherein the positioning information is determined by fusion positioning of Inertial Measurement Unit (IMU), odometer and Real-Time Kinematics (RTK) in the snow sweeper.

9. The trap escaping and snow removal method of claim 1, further comprising:
determining a target push rod value according to relationship between a push rod value and the head-up height of the snow shovel head when adjusting the head-up height of the snow shovel head of the snow sweeper; and
adjusting a current push rod value as the target push rod value to adjust the head-up height of the snow shovel head.

10. The trap escaping and snow removal method of claim 9, wherein different head-up heights of the snow shovel head correspond to different push rod values.

11. A trap escaping and snow removal device, comprising:
a detection module, configured for performing, when a snow sweeper detects that a current snow shoveling position is in a trigger condition for trap escaping, a corresponding preset trap escaping action, wherein the preset trap escaping action comprises following steps: adjusting a head-up height of a snow shovel head of the snow sweeper at least once;
a determination module, configured for determining, after finishing the preset trap escaping action, whether it is still in the trigger condition for trap escaping; and
a snow shoveling module, configured for determining a next snow shoveling position and performing a snow shoveling operation.

12. The trap escaping and snow removal device of claim 11, wherein the trigger condition for trap escaping in the detection module comprises a first trigger condition for trap escaping, and the first trigger condition for trap escaping is: the snow sweeper skids when it is not the first time for the snow sweeper to perform the automatic snow shoveling operation or a motor current of the snow sweeper is greater than a preset threshold;
the detection module is further configured for:
moving back a first preset distance, and adjusting the head-up height of the snow shovel head to a target head-up height;
moving forth a second preset distance, and performing the snow shoveling operation;
determining, if a moving-forth distance reaches a preset distance threshold in the process of moving forth the second preset distance, whether the motor current is greater than the preset threshold; and
if not, continuing to shovel snow with the target head-up height, and adjusting the head-up height of the snow shovel head as a ground-touching height after determining that snow shoveling is finished.

13. The trap escaping and snow removal device of claim 12, wherein the detection module is further configured for:
if yes, moving back the first preset distance on the basis of the moving-forth distance, and adjusting the head-up height of the snow shovel head as the ground-touching height; and
continuing to move forth the second preset distance, and keeping the head-up height of the snow shovel head as the ground-touching height in the process of going to the next snow shoveling position.

14. The trap escaping and snow removal device of claim 12, wherein the trigger condition for trap escaping in the detection module comprises a second trigger condition for trap escaping, and the second trigger condition for trap escaping is: the snow sweeper skids after the snow sweeper performs the automatic snow shoveling operation for the first time or a marked position is manually activated;
the detection module is further configured for:
adjusting the head-up height of the snow shovel head from the ground-touching height according to a preset height interval;
determining whether the snow sweeper at the current snow shoveling position skids based on positioning information of the snow sweeper;
if yes, returning to the step of adjusting the head-up height of the snow shovel head according to the preset height interval until the head-up height of the snow shovel head is adjusted to an upper limit value of the head-up height of the snow shovel head, taking the current snow shoveling position as the marked position, and recording the marked position and a marked head-up height corresponding to the marked position; and
if not, taking the current snow shoveling position as the marked position, and recording the marked position and a marked head-up height corresponding to the marked position.

15. The trap escaping and snow removal device of claim 14, wherein the device is further used for:
adjusting, when the snow sweeper moves to the marked position corresponding to the next snow shoveling position, the head-up height of the snow sweeper to the marked head-up height.

16. A snow sweeper, comprising a snow shovel head, a snow sweeper body and one or more controllers; wherein the snow shovel head is detachably connected to the snow sweeper body, one or more controllers are arranged on the snow sweeper body, one or more controllers are used for controlling the snow shovel head and a snow shovel motor, and one or more controllers can run a trap escaping and snow removal program, and the trap escaping and snow removal program is configured for realizing following steps:
performing, when a snow sweeper detects that a current snow shoveling position is in a trigger condition for trap escaping, a corresponding preset trap escaping action, wherein the preset trap escaping action comprises the following steps: adjusting a head-up height of a snow shovel head of the snow sweeper at least once;
determining, after finishing the preset trap escaping action, whether it is still in the trigger condition for trap escaping; and
if not, determining a next snow shoveling position and performing a snow shoveling operation.

17. The snow sweeper of claim 16, wherein the trigger condition for trap escaping comprises a first trigger condition for trap escaping, and the first trigger condition for trap escaping is: the snow sweeper skids when it is not the first time for the snow sweeper to perform the automatic snow shoveling operation or a motor current of the snow sweeper is greater than a preset threshold; and the trap escaping and snow removal program is configured for further realizing the following steps under the first trigger condition for trap escaping:
moving back a first preset distance, and adjusting the head-up height of the snow shovel head to a target head-up height;
moving forth a second preset distance, and performing the snow shoveling operation;
determining, if a moving-forth distance reaches a preset distance threshold in the process of moving forth the second preset distance, whether the motor current is greater than the preset threshold; and
if not, continuing to shovel snow with the target head-up height, and adjusting the head-up height of the snow shovel head as a ground-touching height after determining that snow shoveling is finished.

18. The snow sweeper of claim 17, wherein the trap escaping and snow removal program is configured for further realizing the following steps:
if yes, moving back the first preset distance on the basis of the moving-forth distance, and adjusting the head-up height of the snow shovel head as the ground-touching height; and
continuing to move forth the second preset distance, and keeping the head-up height of the snow shovel head as the ground-touching height in the process of going to the next snow shoveling position.

19. The snow sweeper of claim 16, wherein the trigger condition for trap escaping includes a second trigger condition for trap escaping, and the second trigger condition for trap escaping is: the snow sweeper skids after the snow sweeper performs the automatic snow shoveling operation for the first time or a marked position is manually activated; and the trap escaping and snow removal program is configured for further realizing the following steps under the second trigger condition for trap escaping:
adjusting the head-up height of the snow shovel head from the ground-touching height according to a preset height interval;
determining whether the snow sweeper at the current snow shoveling position skids based on positioning information of the snow sweeper;
if yes, returning to the step of adjusting the head-up height of the snow shovel head according to the preset height interval until the head-up height of the snow shovel head is adjusted to an upper limit value of the head-up height of the snow shovel head, taking the current snow shoveling position as the marked position, and recording the marked position and a marked head-up height corresponding to the marked position; and
if not, taking the current snow shoveling position as the marked position, and recording the marked position and a marked head-up height corresponding to the marked position.

20. The snow sweeper of claim 19, wherein the trap escaping and snow removal program is configured for further realizing the following steps:
adjusting, when the snow sweeper moves to the marked position corresponding to the next snow shoveling position, the head-up height of the snow sweeper to the marked head-up height.
